(19) United States
(12) Patent Application Publication
(10) Pub. No.: US 2002/0145532 A1
(43) Pub. Date: Oct. 10, 2002

(54) Configuration for wire-free supply of electric power to a large number of sensors and/or actuatiors, sensor or actuator for this purpose and system for a machine having a large number of sensors and/or actuators

(76) Inventors: Guntram Scheible, Hirschberg (DE); Jurgen Fuchs, Schwetzingen (DE); Kai Garrels, Mannheim (DE); Dagfin Brodtkorb, Osteras (NO); Snorre Kjesbu, Siependen (NO)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/027,102

(22) Filed: Dec. 26, 2001

Related U.S. Application Data
(63) Continuation of application No. PCT/EP00/05327, filed on Jun. 9, 2000.

(30) Foreign Application Priority Data
Jun. 26, 1999 (DE) 199 29 343.0

(51) Int. Cl. G08B 23/00

(52) U.S. Cl. 340/693.1; 340/679

(57) ABSTRACT

A configuration and method for the wire-free supply of electric power to a large number of sensors and/or actuators mounted on a machine includes a micro fuel cell with associated fuel tank integrated into the sensors/actuators and converting the stored fuel, preferably methanol, into electric power to supply the sensor. Also included is a sensor or actuator with such an integrated micro fuel cell and fuel tank. Further included is a system for a machine, in particular an automatic production machine, having a large number of sensors/actuators equipped with a transmitting device and/or receiving device communicating through radio signals with a central transmitting and/or receiving device connected to a process computer belonging to the machine, and a micro fuel cell with associated fuel tank integrated into the sensors/actuators and converting the stored fuel into electric power to supply the sensor.

### CROSS-REFERENCE TO RELATED APPLICATION

This application is a continuation of copending International Application PCT/EP00/05327, filed Jun. 9, 2000, which designated the United States.

### BACKGROUND OF THE INVENTION

Field of the Invention

The invention relates to a configuration for the wire-free supply of electric power to a large number of sensors and/or actuators, to a sensor or actuator for such a purpose, and to a system for a machine having a large number of sensors and/or actuators.

The invention can be used, for example, to supply electric power to proximity sensors (or proximity switches), to temperature measuring sensors, to pressure measuring sensors, to current measuring sensors and voltage measuring sensors in industrial robots, to automatic manufacturing machines and automatic production machines, and/or for the supply of electric power to micromechanical, piezoelectric, electrochemical, magnetostrictive, electrostrictive, electrostatic or electromagnetic actuators, such as are used in actuator systems or machines, for example, in open/closed-loop control systems, in remote control systems, in robot engineering, in automatic manufacturing machines or automatic production machines as indicating elements, and in protective and safety systems (for example, in outdoor or indoor switchgear).

German Published, Non-Prosecuted Patent Application DE 44 42 677 A1 discloses a method and a configuration for supplying an electrical load with an electrical supply voltage or an electrical supply current. Radio waves from a radio transmission are transmitted to a radio receiver connected electrically to the load, and are converted by the radio receiver into the electrical supply voltage or the electrical supply current. The radio waves may come from the electromagnetic high-frequency range (radio waves) or from the microwave range (directional radio).

In such a case, it is a drawback that, due to the high frequencies and corresponding small antennae, on one hand, and the permitted transmitting power, which is restricted by EMC regulations and rules for safety and protection of health at workplaces with exposure to electrical, magnetic, or electromagnetic fields, on the other hand, only very inadequately low distances between radio transmitters and radio receivers can be achieved. The same applies to the powers that can be achieved, which lie within the range of a few μW, which is generally inadequate for actuators.

### SUMMARY OF THE INVENTION

It is accordingly an object of the invention to provide a configuration for wire-free supply of electric power to a large number of sensors and/or actuators, a sensor or actuator for such a purpose, and a system for a machine having a large number of sensors and/or actuators that overcomes the hereinafore-mentioned disadvantages of the heretofore-known devices and methods of this general type and that is cost-effective and reliable.

With the foregoing and other objects in view, in a configuration for the wire-free supply of electric power to a plurality of sensors and actuators mounted on a machine there is provided, in accordance with the invention, a control assembly including a controller, a fuel tank for storing fuel, a micro fuel cell associated with the fuel tank, the micro fuel cell converting stored fuel into electric power and supplying the electric power to the controller, and the micro fuel cell and the fuel tank integrated into the controller. Preferably, the stored fuel is methanol.

Such a micro fuel cell is disclosed, for example, by International publication WO 98/31062, corresponding to U.S. Pat. No. 5,759,712 to Hockaday, or International application PCT/US98/01693.

In accordance with another feature of the invention, the controller can be a sensor and/or an actuator.

In accordance with a further feature of the invention, there is provided an electric energy store connected to the fuel cell.

With the objects of the invention in view, there is also provided a control assembly including a controller having an integrated fuel tank for storing fuel and an integrated micro fuel cell associated with the fuel tank, the fuel cell converting stored fuel into electric power and supplying the electric power to the controller.

With the objects of the invention in view, in a machine having a process computer, there is also provided a control system including a central transmitting device connected to the process computer, a central receiving device connected to the process computer, a plurality of controllers including at least one of the group consisting of sensors and actuators, and the controllers each having a transmitting device communicating with the central receiving device through radio signals, a receiving device communicating with the central transmitting device through radio signals, an integrated fuel tank for storing fuel, and an integrated micro fuel cell associated with the fuel tank, the fuel cell converting stored fuel into electric power and supplying the electric power to a respective one of the controllers.

In accordance with an added feature of the invention, the machine is an automatic production machine.

In accordance with an additional feature of the invention, the transmitting device and the receiving device is a combination transmitting and receiving device.

In accordance with yet another feature of the invention, the central transmitting device and the central receiving device is a combination transmitting and receiving device.

With the objects of the invention in view, there is also provided a method for supplying wire-free electric power to controllers including the steps of mounting a plurality of controllers on a machine, each of the controllers having an integrated fuel tank for storing fuel and an integrated micro fuel cell associated with the fuel tank, converting stored fuel in each fuel tank into electric power with each micro fuel cell, and supplying the electric power to each of the controllers from each respective micro fuel cell.

In accordance with yet a further mode of the invention, the controllers include sensors and/or actuators.

In accordance with a concomitant mode of the invention, a central transmitting device and a central receiving device are connected to a process computer, each of the controllers is provided with a transmitting device and a receiving device, and the central receiving device and the central transmitting device communicate with the receiving device and the transmitting device in each of the controllers through radio signals.

The advantages that can be achieved by the invention include, in particular, the fact that, as compared with conventional solutions with a cable connection to supply electric power to the sensors and/or actuators, the relatively high cost factor for a cable connection, caused by the planning, material, installation, documentation and maintenance, is eliminated. Thus, failures occurring because of cable breakages or poor, for example, corroded, contacts no longer occur.

As compared with the use of batteries to supply power to sensors and/or actuators, the maintenance effort and costs that are caused by the necessary replacement of batteries—particularly at points that are difficult to access—are eliminated. The invention also has advantages from an environmental point of view because both the micro fuel cell and the fuel required to generate the electric power are not critical with regard to environmental aspects.

Other features that are considered as characteristic for the invention are set forth in the appended claims.

Although the invention is illustrated and described herein as embodied in a configuration for wire-free supply of electric power to a large number of sensors and/or actuators, a sensor or actuator for such a purpose, and a system for a machine having a large number of sensors and/or actuators, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a perspective block diagram of a system for a machine having a large number of sensors and/or actuators according to the invention; and

FIG. 2 is a block and schematic circuit diagram of an embodiment of a configuration for generating power integrated in a sensor or actuator according to the invention.

### DESCRIPTION OF THE PREFERRED EMBODIMENTS

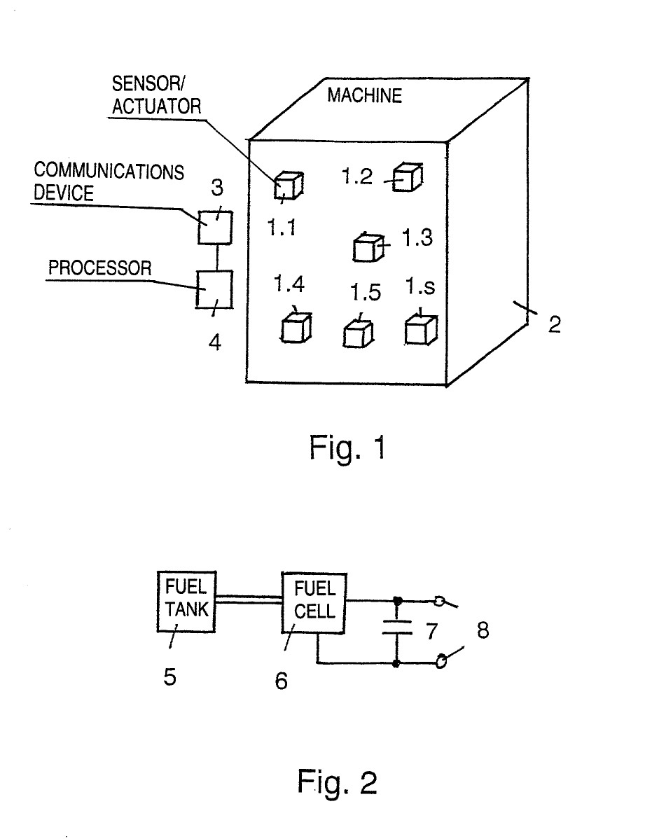

Referring now to the figures of the drawings in detail and first, particularly to FIG. 1 thereof, there is shown a system for a machine having a large number of sensors and/or actuators. FIG. 1 illustrates a machine 2 or an industrial robot or automatic manufacturing machine or automatic production machine that is provided with numerous sensors and/or actuators 1.1 to 1.s mounted on different, possibly mobile, machine components. The sensors used are, in particular, proximity sensors. Furthermore, pressure sensors or temperature sensors, for example, can be used. The actuators 1.1 to 1.s used are, for example, indicating elements, open/closed-loop control elements, and protective/safety elements, such as motor starters, contactors, soft-starters, and pneumatic valves.

The sensors and/or actuators 1.1 to 1.s are equipped with transmitting devices and receiving devices or transmitting/receiving devices that, for example, receive radio signals relating to the commands to the actuators to carry out specific operations and, for example, emit radio signals relating to current sensor information, such as feedback messages “desired position reached” or actuator information, such as feedback messages “desired operation carried out successfully”.

The radio signals to the sensors and/or actuators 1.1 to 1.s and from the sensors and/or actuators 1.1 to 1.s are emitted and received, respectively, by a central transmitting device and receiving device or transmitting/receiving device 3, and are predefined by a process computer 4 (programmable logic controller) or passed on to the computer 4. The central transmitting device and receiving device or transmitting/receiving device 3 is preferably located in the immediate vicinity of the sensors and/or actuators 1.1 to 1.s to ensure an optimum radio link to the sensors and/or actuators. The process computer 4 controlling the machine 2 can be disposed at a distance from the sensors and/or actuators 1.1 to 1.s. Information can be exchanged between process computer 4 and central transmitting device and receiving device or transmitting/receiving device 3 through radio signals or through cables.

The supply of the electric power to the sensors and/or actuators 1.1 to 1.s is provided by micro fuel cells that are integrated into the sensors and/or actuators, as described in more detail below with reference to FIG. 2.

As can easily be seen, the proposed system results in a cable-free configuration of the sensors and/or actuators 1.1 to 1.s, both with regard to their electric power supply and with regard to the transmission of information from and to the central transmitting device and receiving device or transmitting/receiving device 3 and from and to the process computer 4.

FIG. 2 illustrates one embodiment of a power generation configuration integrated in a sensor or actuator. It reveals a micro fuel cell 6 that, on the one hand, is connected to a fuel tank 5 preferably containing methanol and that, on the other hand, has supply terminals 8, at which electric power can be tapped off to feed the transmitting devices or receiving devices or transmitting/receiving devices belonging to the sensors or actuators.

A capacitor 7 or rechargeable battery is expediently located as an intermediate power store between the supply terminals 8 to provide a non-uniform, for example, pulsed, power supply required by the transmitting device and receiving device or transmitting/receiving device belonging to the sensor or actuator.

In such a case, the power required by a sensor is in the region of a few tens of microwatts up to 50 mW, preferably, around 1 mW. The power required by an actuator is in the range from 1 to 50 mW.

The capacity of the fuel tank 5 is preferably configured such that the electric power predicted to be required during the lifetime of the sensor or actuator can be produced. However, it is also possible to provide the fuel tank 5 with non-illustrated devices (i.e., valves) that permit subsequent replenishment.

The micro fuel cell 6 is preferably produced using micro-electromechanical system (MEMS) technology.

We claim:

1. In a configuration for the wire-free supply of electric power to a plurality of sensors and actuators mounted on a machine, a control assembly comprising:
a controller;
a fuel tank for storing fuel;
a micro fuel cell associated with said fuel tank, said micro fuel cell converting stored fuel into electric power and supplying the electric power to said controller; and
said micro fuel cell and said fuel tank integrated into said controller.

2. The control assembly according to claim 1, wherein said controller is at least one of the group consisting of a sensor and an actuator.

3. The control assembly according to claim 1, wherein the fuel is methanol.

4. The control assembly according to claim 3, including an electric energy store connected to said fuel cell.

5. A control assembly, comprising:
a controller having:
an integrated fuel tank for storing fuel; and
an integrated micro fuel cell associated with said fuel tank, said fuel cell converting stored fuel into electric power and supplying the electric power to said controller.

6. The control assembly according to claim 5, wherein said controller is at least one of the group consisting of a sensor and an actuator.

7. The control assembly according to claim 5, wherein the fuel is methanol.

8. The control assembly according to claim 5, including an electric energy store connected to said fuel cell.

9. In a machine having a process computer, a control system comprising:
a central transmitting device connected to the process computer;
a central receiving device connected to the process computer;
a plurality of controllers including at least one of the group consisting of sensors and actuators; and
said controllers each having:
a transmitting device communicating with said central receiving device through radio signals;
a receiving device communicating with said central transmitting device through radio signals;
an integrated fuel tank for storing fuel; and
an integrated micro fuel cell associated with said fuel tank, said fuel cell converting stored fuel into electric power and supplying the electric power to a respective one of said controllers.

10. The control system according to claim 9, wherein the machine is an automatic production machine.

11. The control system according to claim 9, wherein said transmitting device and said receiving device is a combination transmitting and receiving device.

12. The control system according to claim 9, wherein said central transmitting device and said central receiving device is a combination transmitting and receiving device.

13. The control assembly according to claim 9, wherein the fuel is methanol.

14. The control assembly according to claim 13, including an electric energy store connected to said fuel cell.

15. A method for supplying wire-free electric power to controllers, which comprises:
mounting a plurality of controllers on a machine, each of the controllers having:
an integrated fuel tank for storing fuel; and
an integrated micro fuel cell associated with the fuel tank;
converting stored fuel in each fuel tank into electric power with each micro fuel cell; and
supplying the electric power to each of the controllers from each respective micro fuel cell.

16. The method according to claim 15, wherein the controllers include at least one of the group consisting of sensors and actuators.

17. The method according to claim 15, wherein the fuel is methanol.

18. The method according to claim 15, which further comprises connecting an electric energy store to the fuel cell.

19. The method according to claim 15, which further comprises:
connecting a central transmitting device and a central receiving device to a process computer;
providing each of the controllers with:
a transmitting device; and
a receiving device; and
communicating, through radio signals, with the central receiving device and the central transmitting device to the receiving device and the transmitting device in each of the controllers.

20. The method according to claim 15, wherein the transmitting device and the receiving device in at least one of the controllers is a combination transmitting and receiving device.

21. The method according to claim 15, wherein the central transmitting device and the central receiving device is a combination transmitting and receiving device.
